(19) United States
(12) Patent Application Publication
(10) Pub. No.: US 2005/0268771 A1
(43) Pub. Date: Dec. 8, 2005

(54) Musical instrument stand

(76) Inventors: Ron Rhett Yancey, Bradenton, FL (US); Arn Olson, Sarasota, FL (US)

Correspondence Address: American Stand LLC, 8228 Country Oaks Ct., Sarasota, FL, 34243, US

(21) Appl. No.: 10/862,078

(22) Filed: Jun. 7, 2004

(51) Int. Cl. G10D 3/00; G10G 5/00; G10D 7/08

(52) U.S. Cl. 84/327

(57) ABSTRACT

This instrument stand conforms to the body of the instrument it holds, rests at an angle allowing for vertical display of the instrument while also allowing for stability and protection, and includes a shock-absorbing spring which will allow for impacts to the stand while remaining stable. The base of the stand runs nearly parallel to the ground, greatly reducing the chance of the stand rocking and falling over. Integral accessory holders make the stand more useful. A collar restraint will hold the neck of the instrument in place in the case of side impacts.

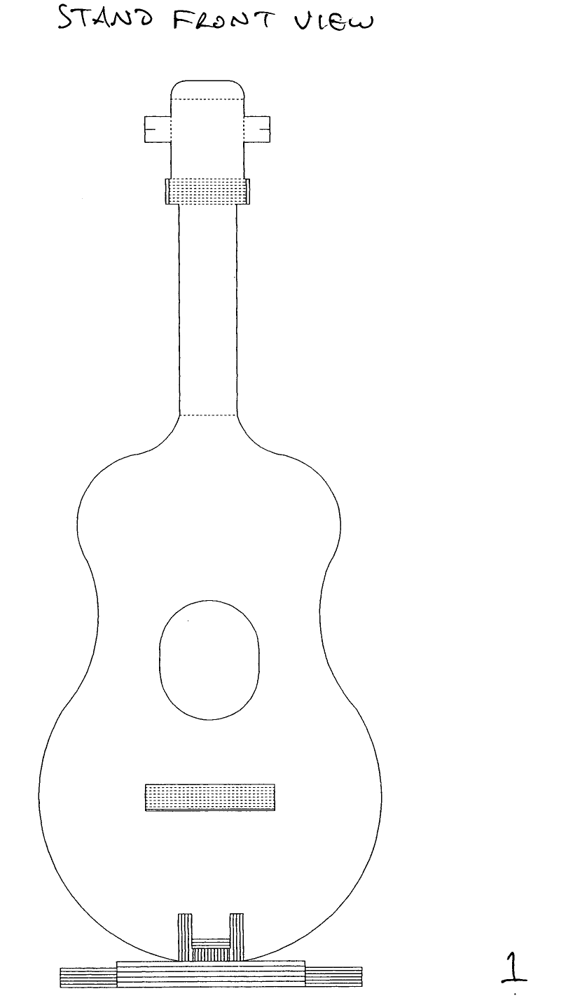

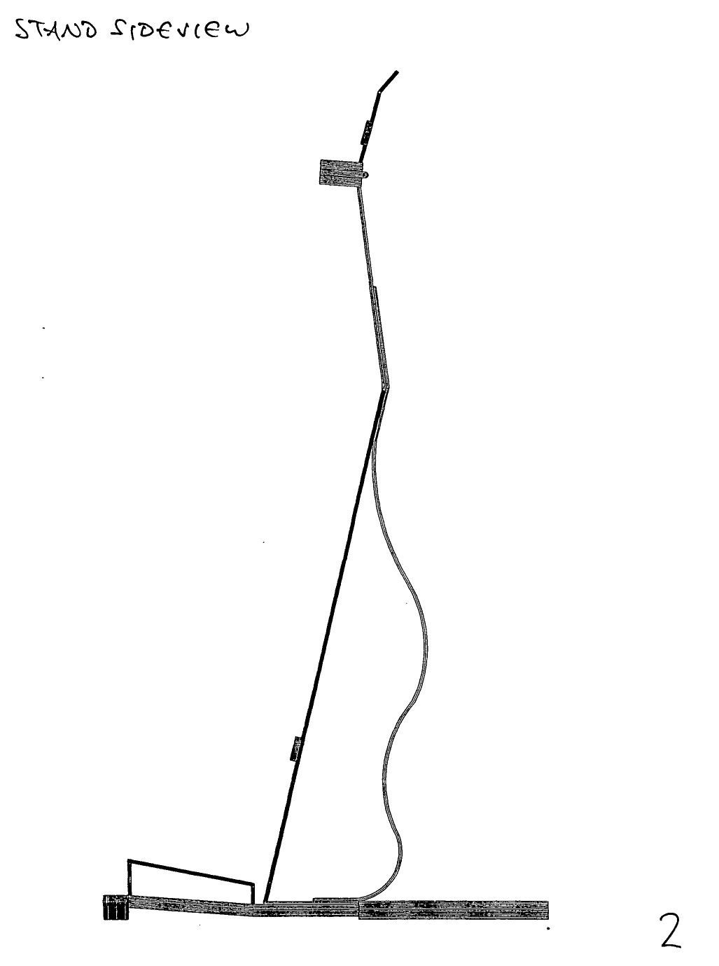

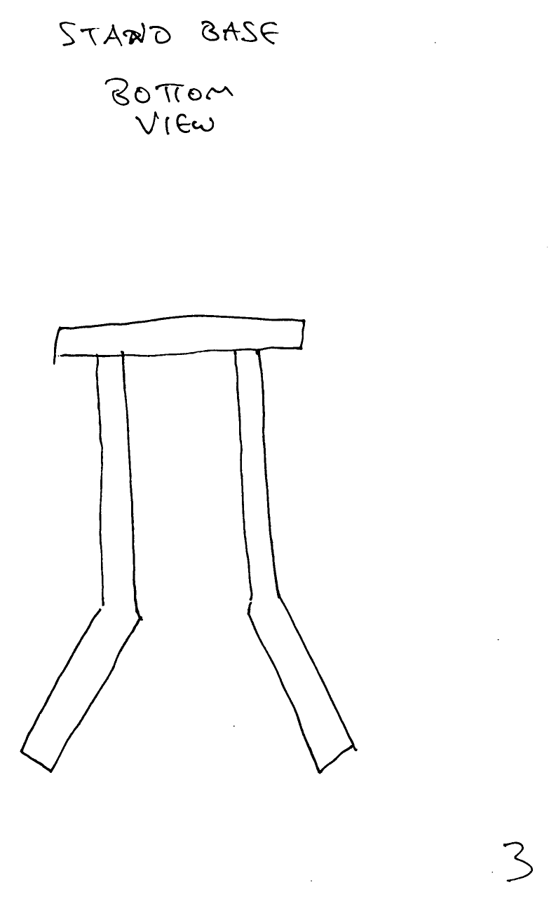

### CROSS REFERENCE TO RELATED APPLICATIONS

n/a

### STATEMENT REGARDING FEDERALLY SPONSORED RESEARCH OF DEVELOPMENT

n/a

### REFERENCE TO SEQUENCE LISTING, A TABLE, OR A COMPUTER PROGRAM LISTING COMPACT DISK APPENDIX

n/a

### BACKGROUND

The dull and wobbly nature of most instrument stands made simply of tubing led us to re-engineer instrument stand design.

### BRIEF SUMMARY OF THE INVENTION

This instrument stand is formed to conform to the shape of the instrument to be held in order to impart stability also included are many more features which will result in a very stable stand.

1. The profile of the stand is formed to match the profile of the instrument.

2. The stand is supported vertically by a shock-absorbing spring.

3. A collar restraint holds the instrument in place on the stand.

4. The legs of the stand are nearly parallel to the ground and are splayed out at opposing angles.

5. The stand includes integral notches for holding accessories.

6. The stand is tilted at such an angle (approx. 20 degrees) as to allow the instrument to rest against it instead of hanging from it.
